(19) United States
(12) Patent Application Publication
(10) Pub. No.: US 2017/0359437 A1
(43) Pub. Date: Dec. 14, 2017

(54) GENERATING JOB RECOMMENDATIONS BASED ON JOB POSTINGS WITH SIMILAR POSITIONS

(71) Applicant: LinkedIn Corporation, Mountain View, CA (US)

(72) Inventors: Jian Wang, Los Altos, CA (US); Krishnaram Kenthapadi, Sunnyvale, CA (US); David Hardtke, Oakland, CA (US)

(21) Appl. No.: 15/178,044

(22) Filed: Jun. 9, 2016

(51) Int. Cl. H04L 29/08; G06Q 10/10; G06Q 50/00

(52) U.S. Cl. CPC H04L 67/306; G06Q 10/10; G06Q 50/01

(57) ABSTRACT

Apparatuses, computer readable medium, and methods are disclosed for generating job recommendations. The method includes determining one or more first job profiles that are similar to a second job profile of a member of a social network system, and determining first regression coefficients and a first hidden feature vector jointly for a first layer of a hierarchical structure based on the one or more first job profiles and the second job profile. The method may further include determining one or more third job profiles that are similar to the second job profile, wherein the one or more third job profiles are from a same company as the second job profile, and determining second regression coefficients and a second hidden feature vector jointly for a second layer of the hierarchical structure based on the first regression coefficients, the first hidden feature vector, and the one or more third job profiles.

### TECHNICAL FIELD

Embodiments pertain to generating recommendations. Some embodiments relate to determining regression coefficients and hidden feature vectors jointly for each layer of a hierarchical structure based on a previous layer of the hierarchical structure. Some embodiments relate to using job similarity to determine the hierarchical structure and regression coefficients. Some embodiments relate to generating job recommendations for members of a social network system.

### BACKGROUND

Presenting recommendations (e.g., jobs) to members of a social network system can be a valuable service to the member and the employer or recruiter. The job recommendations may help a passive or active job applicant find a job and job recommendations may help employers or recruiters fill open jobs. Determining job recommendations is a computationally demanding when the social network system includes large numbers of members and potentially a large number of jobs. Moreover, displaying bad job recommendations may dissuade a member from using the social network system or encourage the member to turn off job recommendations.

### DESCRIPTION OF THE DRAWINGS

Some embodiments are illustrated by way of example and not limitation in the FIGS. of the accompanying drawings, in which:

FIG. 1 is a block diagram of a social network system in accordance with some embodiments;

FIG. 2 illustrates a job recommendation engine in accordance with some embodiments;

FIG. 3 illustrates dependencies of variables in the hierarchical member interaction structure in accordance with some embodiments;

FIG. 4 illustrates the job similarity determiner in accordance with some embodiments;

FIG. 5 illustrates a method for generating job recommendations in accordance with some embodiments;

FIG. 6 illustrates a method of determining regression coefficients and a hidden feature vector of a hierarchical structure in accordance with some embodiments; and

FIG. 7 shows a diagrammatic representation of the machine in the example form of a computer system and within which instructions (e.g., software) for causing the machine to perform any one or more of the methodologies discussed herein may be executed.

### DETAILED DESCRIPTION

The present disclosure describes methods, systems and computer program products for improving the generating job recommendations. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

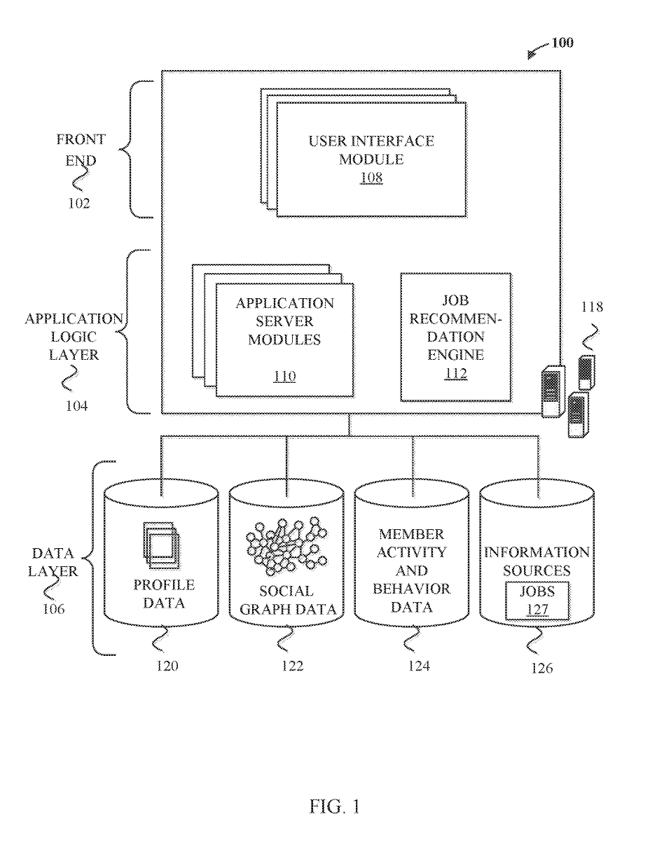

FIG. 1 is a block diagram of a social network system 100 in accordance with some embodiments. The social network system 100 may be based on a three-tiered architecture, comprising a front-end layer 102, application logic layer 104, and data layer 106. Some embodiments implement the social network system 100 using different architectures. The social network system 100 may be implemented on one or more computers 118. The computers 118 may be servers, personal computers, laptops, portable devices, etc. The social network system 100 may be implemented in a combination of software, hardware, and firmware.

As shown in FIG. 1, the front end 102 includes user interface modules 108. The user interface modules 108 may be one or more web services. The user interface modules receive requests from various client-computing devices, and communicate appropriate responses to the requesting client devices. For example, the user interface modules 108 may receive requests in the form of Hypertext Transport Protocol (HTTP) requests, or other web-based, application programming interface (API) requests. The client devices (not shown) may be executing web browser applications, or applications that have been developed for a specific platform to include any of a wide variety of mobile devices and operating systems.

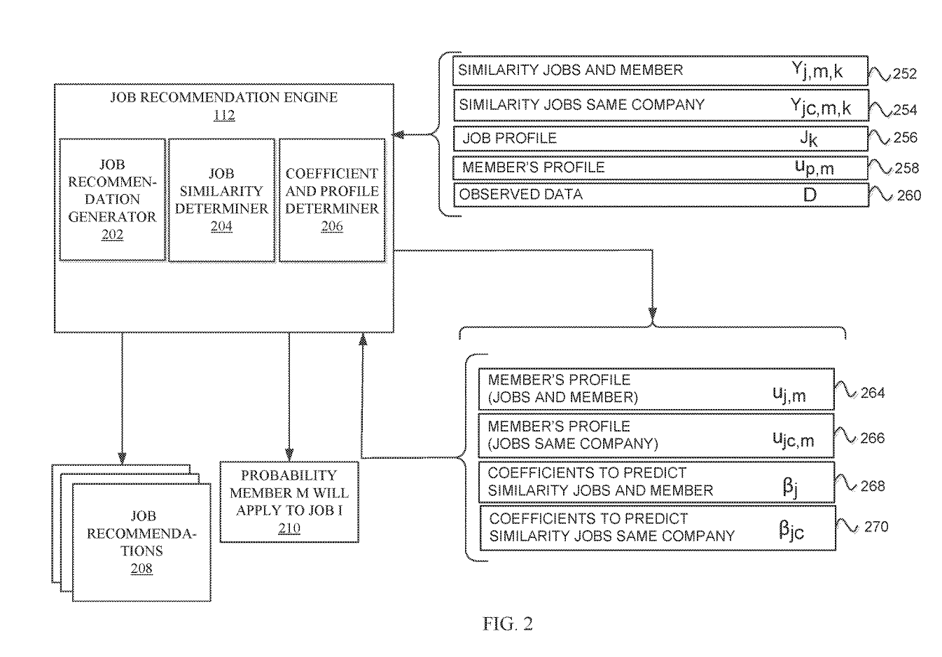

As shown in FIG. 1, the data layer 106 includes profile data 120, social graph data 122, member activity and behaviour data 124, and information sources 126. Profile data 120, social graph data 122, and member activity and behaviour data 124, and/or information sources 126 may be databases. One or more of the data layer 106 may store data relating to various entities represented in a social graph. In some embodiments, these entities include members, companies, and/or educational institutions, among possible others. Consistent with some embodiments, when a person initially registers to become a member of the social network system 100, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's member profile, for example, in profile data 120. The profile data 120 may include the member's profile u_{p,m} 258 (see FIG. 2), member's profile (jobs same company) u_{jc,m} 266, similarity jobs and member Y_{j,m,k} 252, similarity jobs same company Y_{jc,m,k} 254, coefficients to predict similarity jobs and member βⱼ 268, and coefficients to predict similarity jobs same company β_{jc} 270.

With some embodiments, a member's profile data will include not only the explicitly provided data, but also any number of derived or computed member profile attributes and/or characteristic, which may become part of one of more of profile data 120, social graph data 122, member activity and behaviour data 124, and/or information sources 126. Below Table 2 discloses some example fields of a member's profile u_{p,m} 258.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of“following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data 122. With some embodiments the social graph data 122 may be implemented with a graph database, which is a particular type of database that uses graph structures with nodes, edges, and properties to represent and store data. In this case, the social graph data 122 reflects the various entities that are part of the social graph, as well as how those entities are related with one another.

With various alternative embodiments, any number of other entities might be included in the social graph data 122, and as such, various other databases may be used to store data corresponding with other entities. For example, although not shown in FIG. 1, consistent with some embodiments, the system may include additional databases for storing information relating to a wide variety of entities, such as information concerning various online or offline people, job announcements, companies, groups, posts, slideshares, and so forth.

With some embodiments, the application server modules 110 may include one or more activity and/or event tracking modules, which generally detect various user-related activities and/or events, and then store information relating to those activities/events in, for example, member activity and behaviour data 124. For example, the tracking modules may identify when a user makes a change to some attribute of his or her member profile, or adds a new attribute. Additionally, a tracking module may detect the interactions that a member has with different types of content. For example, a tracking module may track a member's activity with respect to job announcements, e.g. job announcement views, saving of job announcements, applications to a job in a job announcement, explicit feedback regarding a job announcement (e.g., not interested, not looking, too junior, not qualified, information regarding the job the member would like, a location member wants to work, do not want to move, more like this, etc.), job search terms that may be entered by a member to search for job announcements. Such information may be used, for example, by one or more recommendation engines to tailor the content presented to a particular member, and generally to tailor the user experience for a particular member.

Information sources 126 may be one or more additional information sources. For example, information sources 126 may include ranking and business rules, historical search data, and reference data as well as people, jobs 127, which may include a job profile Jᵢ 256 (FIG. 2), job announcements (not illustrated), etc.

The application server modules 110, which, in conjunction with the user interface module 108, generate various user interfaces (e.g., web pages) with data retrieved from the data layer 106. In some embodiments, individual application server modules 110 are used to implement the functionality associated with various applications, services and features of the social network service. For instance, a messaging application, such as an email application, an instant messaging application, or some hybrid or variation of the two, may be implemented with one or more application server modules 110. Of course, other applications or services may be separately embodied in their own application server modules 110. In some embodiments applications may be implemented with a combination of application service modules 110 and user interface modules 108. For example, a job recommendation engine 112 may be implemented with a combination of back-end modules, front-end modules, and modules that reside on a user's computer 118. For example, the social network system 100 may download a module to a web browser running on a user's computer 118, which may communicate with a module running on a server 118 which may communicate with a module running on a back-end database server 118.

The social network system 100 may provide a broad range of applications and services that allow members the opportunity to share and receive information, often customized to the interests of the member. For example, with some embodiments, the social network system 100 may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in social graph data 122. When a member joins a group, his or her membership in the group may be reflected in the social graph data 118 and/or a member's profile U_{p,m}. In some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and structured with the social graph data 118 and may be reflected in the a member's profile U_{p,m}.

In addition to the various application server modules 110, the application logic layer includes a job recommendation engine 112. As illustrated in FIG. 1, with some embodiments the job recommendation engine 112 is implemented as a service that operates in conjunction with various application server modules 110 and user interface modules 108. For instance, any number of individual application server modules 110 can invoke the functionality of the job recommendation engine 112. However, with various alternative embodiments, the job recommendation engine 112 may be implemented as its own application server module 110 such that it operates as a stand-alone application.

The job recommendation engine 112 may search the data layer 106 and determine jobs 127 to present to a member. In some embodiments, the job recommendation engine 112 may determine jobs 127 that should not be presented to a member. In some embodiments, the job recommendation engine 112 works offline to prepare jobs 127 to present to a member. In some embodiments, the job recommendation engine 112 may be used by a recruiter to generate a list of members that may be interested in a particular job 127. The recruiter may pay to push the job 127 to the member or members.

With some embodiments, the job recommendation engine 112 may include or have an associated publicly available application programming interface (API) that enables third-party applications to invoke the functionality of the job recommendation engine 112.

As is understood by skilled artisans in the relevant computer and Internet-related arts, each engine shown in FIG. 1 represents a set of executable software instructions and the corresponding hardware (e.g., memory and processor) for executing the instructions. To avoid obscuring the disclosed embodiments with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the disclosed embodiments are by no means limited to such architecture.

FIG. 2 illustrates a job recommendation engine 112 in accordance with some embodiments. Illustrated in FIG. 2 is job recommendation engine 112, similarity jobs and member Y_{j,m,k} 252, similarity jobs same company Y_{jc,m,k} 254, job profile Jₖ 256, member's profile u_{p,m} 258, observed data D 260, member's profile (jobs and member) u_{j,m} 264, member's profile (jobs same company) u_{jc,m} 266, coefficients to predict similarity jobs and member βⱼ 268, coefficients to predict similarity jobs same company β_{jc} 270, job recommendations 208, and probability member M will apply to job I 210.

Lowercase M is used to indicate the index of the member for 1, 2, . . . , M members. Lowercase K is used to indicate the index of the job for 1, 2, . . . , N jobs.

In some embodiments, the similarity jobs and member Y_{j,m,k} 252 indicates the similarity between a job profile Jₖ 256 and member m's current position in the member's profile u_{p,m} 258. For example, if similarity jobs and member Y_{j,m,k} 252=1, it indicates that member m's current job position listed in the member's profile u_{p,m} 258 is similar to job profile Jₖ 256 otherwise similarity jobs and member Y_{j,m,k} 252=−1. In some embodiments, job similarity determiner 204 is configured to determine similarity jobs and member Y_{j,m,k} 252 for jobs 127 with job profile Jₖ 256 with the current job position in the member's profile u_{p,m} 258, where m=1, 2, . . . , M is the index of the member, and k=1, 2, . . . , N is the index of the job. The similarity jobs and member Y_{j,m,k} 252 may be stored as part of the member activity and behaviour data 124.

In some embodiments, the similarity jobs same company Y_{jc,m,k} 254 indicates the similarity between a job profile Jₖ 256 of a job in a same company as member m's current job position in the member's profile u_{p,m} 258. For example, if similarity jobs same company Y_{jc,m,k} 254=1, it indicates that member m's current position in the member's profile u_{p,m} 258 is similar to job profile Jₖ 256 (in the same company as member's m current position) otherwise similarity jobs same company Y_{jc,m,k} 254=−1. In some embodiments, job similarity determiner 204 is configured to determine similarity jobs same company Y_{jc,m,k} 254 for jobs 127 with job profile Jₖ 256 that are in the same company as member's m current position with the current job position in the member's profile u_{p,m} 258, where m=1, 2, . . . , M is the index of the member, and k=1, 2, . . . , N is the index of the job. The similarity jobs same company Y_{jc,m,k} 254 may be stored as part of the member activity and behaviour data 124.

In some embodiments, the job profile Jₖ 256 is vector fields or features associated with job k of jobs 127. The vector includes static features that are derived from the job description, e.g. job title, qualifications, job location, etc. The job profile Jₖ 256 may be stored in information sources 126. The job profile Jₖ 256 is a profile of a job 127, which, in some embodiments, has one or more job announcements or postings associated with the job profile Jₖ 256 or job 127. Table 1 illustrates example fields of the job profile Jₖ 256.

TABLE 1
EXAMPLE JOB PROFILE FIELDS

<targetField entityType=“JOB” name=“listing type”/>
<targetField entityType=“JOB” name=“job seniority”/>
<targetField entityType=“JOB” name=“industry category”/>
<targetField entityType=“JOB” name=“company size”/>
<targetField entityType=“JOB” name=“company locations”/>
<targetField entityType=“JOB” name=“job opening locations”/>
<targetField entityType=“JOB” name=“job seniority minimum”/>
<targetField entityType=“JOB” name=“geographical country”/>
<targetField entityType=“JOB” name=“skills”>
<targetField entityType=“JOB” name=“description of job”>
<targetField entityType=“JOB” name=“company Description”>
<targetField entityType=“JOB” name=“functions to be performed”>
<targetField entityType=“JOB” name=“job seniority preferred”>
<targetField entityType=“JOB” name=“standardized skills required”>
<targetField entityType=“JOB” name=“relevant standardized skills”>
<targetField entityType=“JOB” name=“job title”>
<targetField entityType=“JOB” name=“job title as a string”>
<targetField entityType=“JOB” name=“industry category”>

In some embodiments, the member's profile u_{p,m} 258 is a vector of profile-based features associated with user m. The vector includes static demographic features that are derived from the user profile information. The member's profile u_{p,m} 258 may be stored in the profile data 120.

Table 2 is an example of member's profile u_{p,m} 258 fields.

TABLE 2
EXAMPLE MEMBER PROFILE FIELDS

<sourceField entityType=“MEMBER” name=“associations”>
<sourceField entityType=“MEMBER” name=“current functions”>
<sourceField entityType=“MEMBER” name=“current normalized title
seniority years”/>
<sourceField entityType=“MEMBER” name=“current position
summary”>
<sourceField entityType=“MEMBER” name=“current title short form”>
<sourceField entityType=“MEMBER” name=“current title string”>
<sourceField entityType=“MEMBER” name=“current title”>
<sourceField entityType=“MEMBER” name=“current company name”>
<sourceField entityType=“MEMBER” name=“Custom plus latent
preferences with regard to location”>
<sourceField entityType=“MEMBER” name=“custom plus latent
preferences with regard to senority”>
<sourceField entityType=“MEMBER” name=“degrees”>
<sourceField entityType=“MEMBER” name=“education notes”>
<sourceField entiryType=“MEMBER” name=“headline”>
<sourceField entityType=“MEMBER” name=“honors”>
<sourceField entityType=“MEMBER” name=“interests”>
<sourceField entityType=“MEMBER” name=“job seniority previous
jobs”>
<sourceField entityType=“MEMBER” name=“past functions”>
<sourceField entityType=“MEMBER” name=“past position summary”>
<sourceField entityType=“MEMBER” name=“past title string”>
<sourceField entityType=“MEMBER” name=“past titles”>
<sourceField entityType=“MEMBER” name=“location”>
<sourceField entityType=“MEMBER” name=“preferences company
size”/>
<sourceField entityType=“MEMBER” name=“preferences industry
category”/>
<sourceField entityType=“MEMBER” name=“preferences location”/>
<sourceField entityType=“MEMBER” name=“preferences seniority”/>
<sourceField entityType=“MEMBER” name=“resolved company size”>
<sourceField entityType=“MEMBER” name=“resolved country”/>
<sourceField entityType=“MEMBER” name=“resolved industry
category”>
<sourceField entityType=“MEMBER” name=“standardized skills as
string”>
<sourceField entityType=“MEMBER” name=“standardized skills”>
<sourceField entityType=“MEMBER” name=“summary”>

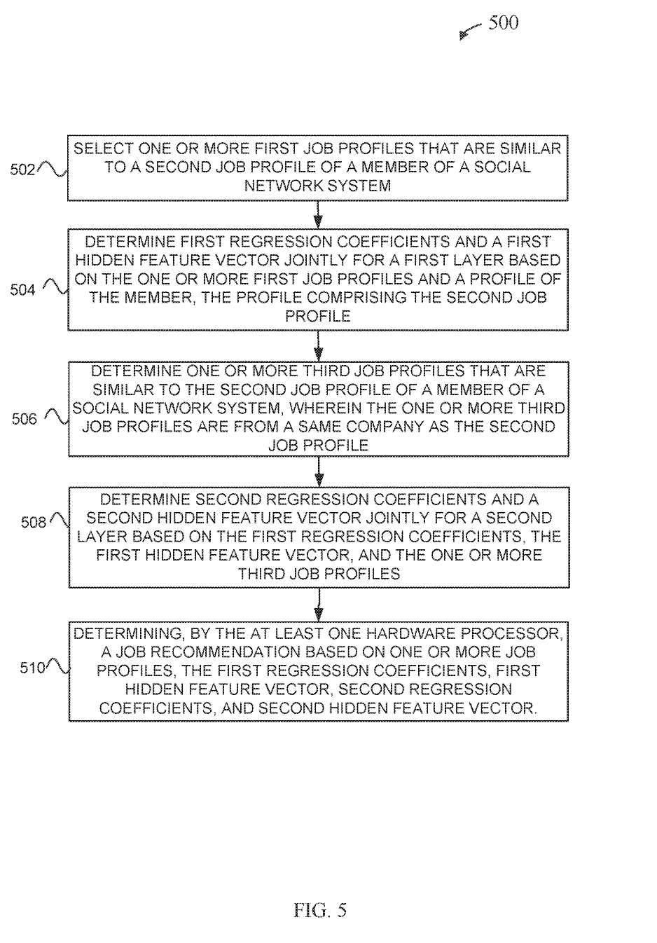

In some embodiments, the member's profile (jobs and member) u_{j,m} 264 is a vector of features based on similarity between job profile Jₖ 256 and the member profile u_{p,m} 258. The vector is tuned according to the similarity between job profiles Jₖ and member's profile u_{p,m} 258 as indicated by similarity jobs and member Y_{j,m,k} 252. The member's profile (jobs and member) u_{j,m} 264 may be stored in the profile data 120. In some embodiments, σⱼ is the variance of the distribution of the member's profile (jobs and member) u_{j,m} 264, which may be determined by the job recommendation engine 112. In some embodiments, the job recommendation engine 112 tunes σⱼ to affect the influence of the member's profile (jobs and member) u_{j,m} 264 on a next step of a hierarchical approach (see FIG. 5). In some embodiments, the coefficient and profile determiner 206 generates the member's profile (jobs and member) u_{j,m} 264 based on one or more of the member's profile u_{p,m} 258, similarity jobs and member Y_{j,m,k} 252, similarity jobs same company Y_{jc,m,k} 254, job profile Jₖ 256, member's profile (jobs same company) u_{jc,m} 266, coefficients to predict similarity jobs and member βⱼ 268, and coefficients to predict similarity jobs same company β_{jc}.

In some embodiments, the member's profile (jobs same company) u_{jc,m} 266 is a vector of features based on a similarity between job profile Jₖ 256 (from the same company as member m's current job) and the member profile u_{p,m} 258. The vector is tuned according to the similarity between job profiles Jₖ (from the same company as member m's job) and member's profile u_{p,m} 258 as indicated by similarity jobs same company Y_{jc,m,k} 254. The member's profile (jobs same company) u_{jc,m} 266 may be stored in the profile data 120. In some embodiments, σ_{jc} is the variance of the member's profile (jobs same company) u_{jc,m} 266, which may be determined by the job recommendation engine 112. In some embodiments, the job recommendation engine 112 tunes σ_{jc} to affect the influence of the member's profile (jobs same company) u_{jc,m} 266 on a next step of a hierarchical approach (see FIG. 5). In some embodiments, the coefficient and profile determiner 206 generates the member's profile (jobs same company) u_{jc,m} 266 based on one or more of the member's profile u_{p,m} 258, similarity jobs and member Y_{j,m,k} 252, similarity jobs same company Y_{jc,m,k} 254, job profile Jₖ 256, member's profile (jobs same company) u_{jc,m} 266, coefficients to predict similarity jobs and member βⱼ 268, and coefficients to predict similarity jobs same company β_{jc}.

In some embodiments, observed data D 260 is observed data of all members, e.g., D={D₁, . . . . Dₘ . . . , D_{M}}. The observed data D 260 is stored in the member activity and behaviour data 124 in accordance with some embodiments.

In some embodiments, Dₘ={Y_{j,m,k}, Y_{jc,m,k}, u_{p,m}, jₖ} is a set of observed data associated with user m. Each observation is associated with four parts: similarity jobs and member Y_{j,m,k} 252, similarity jobs same company Y_{jc,m,k} 254, member's profile U_{p,m} 258, and job profile Jₖ 256. The Dₘ is stored in the member activity and behaviour data 124 in accordance with some embodiments.

In some embodiments, the coefficients to predict similarity jobs and member βⱼ 268 is a d-dimensional vector of regression coefficients to predict the similarity jobs and member Y_{j,m,k} 252 for a job profile Jₖ and member m with member's profile u_{p,m} 258. In some embodiments, the coefficients to predict similarity jobs and member βⱼ 268 is generated by the coefficient and profile determiner 206 (e.g., FIG. 5). The coefficients to predict similarity jobs and member βⱼ 268 may be stored in the member activity and behavior data 124.

In some embodiments, the coefficients to predict similarity jobs same company β_{jc} 270 is a d-dimensional vector of regression coefficients to predict the similarity jobs same company Y_{jc,m,k} 254 for a job profile Jₖ and member m with member's profile u_{p,m} 258. In some embodiments, the coefficients to predict similarity jobs same company β_{jc} 270 is generated by the coefficient and profile determiner 206 (e.g., FIG. 5). The coefficients to predict similarity jobs same company β_{jc} 270 may be stored in the member activity and behavior data 124.

The job recommendations 208 are generated by the job recommendation generator 202 where jobs 127 are selected based on one or more of the coefficients to predict similarity jobs and member βⱼ 268, coefficients to predict similarity jobs same company β_{jc} 270, job profile Jₖ 256, member's profile u_{p,m} 258, member's profile (jobs and member) u_{j,m} 264, member's profile (jobs same company) u_{jc,m} 266. The job recommendation generator 202 may use the coefficients to predict similarity jobs and member βⱼ 268, coefficients to predict similarity jobs same company β_{jc} 270 to select the jobs 127 for the job recommendations 208.

The probability member M will apply to job I 209 may be determined by the job recommendation engine 112 based on one or more of the coefficients to predict similarity jobs and member βⱼ 268, coefficients to predict similarity jobs same company β_{jc} 270, job profile Jₖ 256, member's profile u_{p,m} 258, member's profile (jobs and member) u_{j,m} 264, member's profile (jobs same company) u_{jc,m} 266. The probability member M will apply to job I 209 may be based on the job I 209 being displayed to the member M in a certain fashion, e.g., the job I 209 may be displayed with a standard font size and with a standard number of lines.

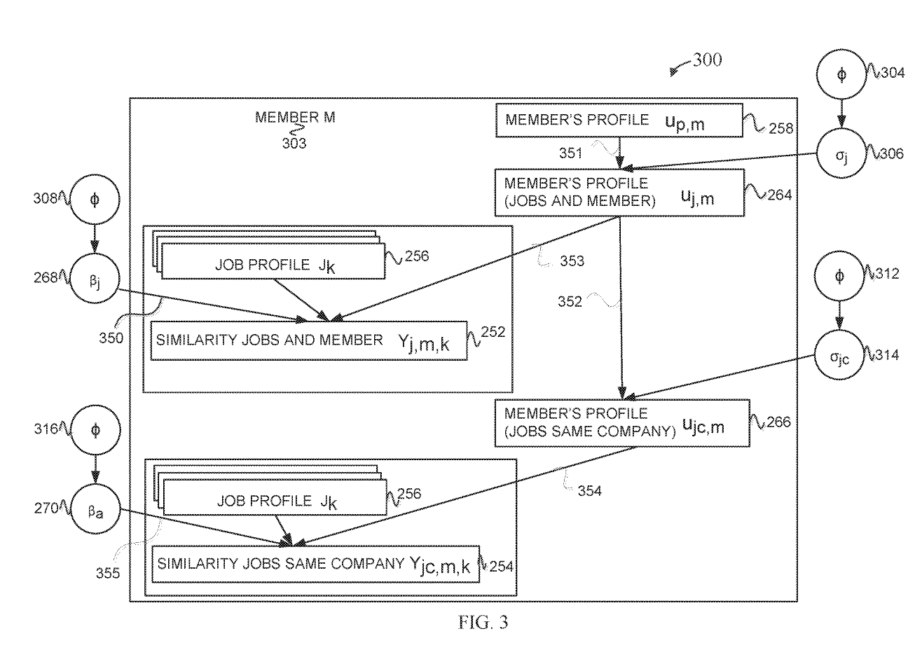

FIG. 3 illustrates dependencies of variables 300 in the hierarchical member interaction structure in accordance with some embodiments. Illustrated in FIG. 3 is φ 304, σⱼ 306, φ 312, σ_{jc} 314, φ 308, coefficients to predict similarity jobs and member βⱼ 268, φ 316, coefficients to predict similarity jobs same company β_{jc} 270, member's profile u_{p,m} 258, member's profile (jobs and member) u_{j,m} 264, job profile Jₖ 256, similarity jobs and member Y_{j,m,k} 252, member's profile (jobs same company) u_{jc,m} 266, similarity jobs same company Y_{jc,m,k} 254, and member m 303. The hierarchical member interaction structure is for member m 303.

The arrows in FIG. 3 indicate that the variable at the origin of the arrow is dependent on the variable at the end of the arrow. For example, arrow 350 indicates that coefficients to predict similarity jobs and member βⱼ 268 is dependent on similarity jobs and member Y_{j,m,k} 252. For example, the coefficients to predict similarity jobs and member βⱼ 268 may be determined by the job recommendation engine 112 based on the similarity jobs and member Y_{j,m,k} 252.

In some embodiments the job recommendation engine 112 structures the parameters as follows. The σⱼ 306 is the variance of the member's profile (jobs and member) u_{j,m} 264. The σ_{jc} 314 is the variance of the member's profile (jobs same company) u_{jc,m} 266. M is the member M 303. The φ's 304, 308, 312, 316=(μ_{β}_{ⱼ}, σ_{β}_{ⱼ}, μ_{β}_{_{jc}}, μ_{σ}_{ⱼ}, σ_{σ}_{ⱼ}, μ_{σ}_{_{jc}}, σ_{σ}_{_{jc}}). The σⱼ 306 is the variance of distribution where member's profile (jobs and member) u_{j,m} 264 is drawn from. The σ_{jc} 314 is the variance of the distribution where member's profile (jobs same company) u_{jc,m} 266 is drawn from. In some embodiments, the job recommendation engine 112 assumes that the parameters are drawn from a Gaussian distribution indicated by N. For example, Equations (1a), (1b), (1c), and (1d):

βⱼ˜N(μ_{β}_{ⱼ},σ_{β}_{ⱼ}); Equation (1a):

β_{jc}˜N(μ_{β}_{_{jc}},σ_{β}_{_{jc}}); Equation (1b):

σⱼ˜N(μ_{σ}_{ⱼ},σ_{σ}_{ⱼ}); and Equation (1c):

σ_{jc}˜N(μ_{σ}_{_{jc}},σ_{σ}_{_{jc}}). Equation (1d):

In some embodiments the job recommendation engine 112 structures the user feature vectors as follows. The job recommendation engine assumes that the member's profile (jobs and member) u_{j,m} 264 follows a Gaussian distribution with member's profile u_{p,m} 258 as the mean and σⱼ as the variance. The job recommendation engine 112, in some embodiments, assumes that member's profile (jobs same company) u_{jc,m} 266 follows a Gaussian distribution with the member's profile (jobs and member) u_{j,m} 264 as the mean and σⱼ as the variance. These relationships are described in Equations (2a) and (2b).

u_{j,m}˜N(u_{p,m},σⱼ); and Equation (2a):

u_{jc,m}˜N(u_{j,m},σ_{jc}). Equation (2b):

In some embodiments, the job recommendation engine 112 tunes σⱼ and σ_{jc} to control the weight of the prior fields that come from the member's profile u_{p,m} 258 fields. The higher the variance σⱼ, the less important the member's profile u_{p,m} 258 fields (e.g., the less important the dependency is expressed by arrow 351). The job recommendation engine 112 can give more weight to the member's profile (jobs and member) u_{j,m} 264 and less weight to the member's profile u_{p,m} 258 fields by adjusting σⱼ.

The higher the variance σ_{jc}, the less important the member's profile (jobs and member) u_{j,m} 264 fields (e.g., the less important the dependency that is expressed by arrow 352). The job recommendation engine 112 can give more weight to the member's profile (jobs same company) u_{jc,m} 266 and less weight to the member's profile u_{p,m} 260 fields and member's profile (jobs and member) u_{j,m} 264 by adjusting σ_{jc}.

The similarity signal may be structured by the job recommendation engine 112 as follows. The similarity jobs and member Y_{j,m,k} 252 is dependent on (arrow 253) member's profile (jobs and member) u_{j,m} 264 fields and dependent on (arrow 350) coefficients to predict similarity jobs and member βⱼ 268. The similarity jobs same company Y_{jc,m,k} 254 is dependent on (arrow 354) the member's profile (jobs same company) u_{jc,m} 266 and is dependent on (arrow 355) the coefficients to predict similarity jobs same company β_{jc} 270.

In some embodiments, the job recommendation engine 112 uses logistic regression to predict member action as described in Equations (3a) and (3b).

p(y_{j,m,k}|u_{j,m},βⱼ)=1/(1+exp(−y_{j,m,k}(βⱼ^{T}f(jₖ,u_{j,m})))), Equation (3a):

where Equation (3a) expresses the probability of similarity jobs and member Y_{j,m,k} 252, given u_{j,m}, and βⱼᵥ; and, βⱼ^{T} are the coefficients to predict similarity jobs and member βⱼ 268 transposed (T).

p(y_{jc,m,k}|μ_{jc,m},β_{jc})=1/(1+exp(−y_{jc,m,k}(β_{jc}^{T}f(jₖ,u_{jc,m})))), Equation (3b):

where Equation (3b) expresses the probability of similarity jobs same company Y_{jc,m,k} 254 given u_{jc,m} and β_{jca}; and, β_{jc}^{T} are the coefficients to predict similarity jobs same company β_{jc} 270 transposed (T).

In some embodiments, the job recommendation engine 112 assumes that the data is independent identically distributed to represent the data likelihood as in Equation (4).

p(D|φ)=∫p(D,θ_{g}|φ)dθ_{g}=∫p(D|θ_{g},φ)p(θg|φ)dθ_{g}=∫[Πₘ₌₁^{M}p(yₘ|θ_{g},φ)]p(θ_{g}|φ)dθ_{g}, Equation (4):

where θ_{g}=β_{jc}, βⱼ, σ_{jc}, σⱼ, and θ_{g} is a random variable denoting the joint distribution of the global random variables, β_{jc}, βⱼ, σ_{jc}, and σⱼ.

The job recommendation engine 112 may determine the data likelihood for member m as follows:

p(yₘ|θ_{g},φ)=∫p(yₘ|θₘ,θ_{g},φ)*p(θₘ|θ_{g},φ)dθₘ, Equation (5):

where

p(yₘ|θₘ,θ_{g},φ)*p(θₘ|θ_{g},φ)=Πₖ₌₁^{K}^{ₘ}[P(y_{j,m,k}|u_{j,m},βⱼ)*p(y_{jc,m,k}|u_{jc,m},β_{jc})]*p(u_{jc,m}|u_{j,m},σ_{jc})p(u_{j,m}|σⱼ),

where θₘ=(u_{j,m} and u_{jc,m}) is a random variable denoting the joint distribution of the view based vector and application based vector random variables for each member m.

The job recommendation engine 112 may maximize the likelihood of p(D, φ), which is equivalent to maximizing the log likelihood of Equation (6):

L(D|φ)=ln p(D|φ).

There is no closed form solution to Equations (5) or (6), so, in some embodiments, the job recommendation engine 112 uses a method which is an iterative process to find an approximate solution, in accordance with some embodiments. The job recommendation engine 112 uses an Estimate (E) step where the regression structure is fixed and the user interaction-based vector is varied, and a Maximizing (M) step where the user interaction-based vector is fixed and the regression structure is varied. The job recommendation engine 112 (e.g., the coefficient and profile determiner) determines the member's profile (jobs and member) u_{j,m} 264, member's profile (jobs same company) u_{jc,m} 266, coefficients to predict similarity jobs and member βⱼ 268, and coefficients to predict similarity jobs same company β_{jc} 270 in accordance with Equation (5).

In some embodiments, the iteration process includes a portion for each layer of the hierarchical member interaction structure (see FIG. 3). For example, the job recommendation engine 112 uses an Estimate (E) step where the coefficients to predict similarity jobs and member βⱼ 268 is fixed and the member's profile (jobs and member) u_{j,m} 264 is varied (with the other structure parameters being used including job profile Jₖ, member's profile u_{p,m} 258, variance σⱼ 306, φ 304, and φ 306) then the job recommendation engine 112 goes through a Maximizing (M) step where coefficients to predict similarity jobs and member βⱼ 268 is varied and the member's profile (jobs and member) u_{j,m} 264 is fixed (with the other structure parameters being used including job profile Jₖ member's profile u_{p,m} 258, variance σⱼ 306, φ 304, and φ 306). The job recommendation engine 112 iterates through these steps until they converge on a solution. In some embodiments, during the Maximizing (M) step, other regression structure variables other than the coefficients to predict similarity jobs and member βⱼ 268 may be varied, e.g. any of the variables associated with φ 304 or φ 308. The job recommendation engine 112 may iterate until a change in the member's profile (jobs and member) u_{j,m} 264 is below a predetermined threshold and/or a change coefficients to predict similarity jobs and member βⱼ 268 is below a predetermined threshold.

The job recommendation engine 112 may use the Estimate (E) and Maximizing (M) steps for each layer of the hierarchy (see FIG. 3.) For example, the job recommendation engine 112 determines the coefficients to predict similarity jobs and member βⱼ 268 and the member's profile (jobs and member) u_{j,m} 264, and then determine coefficients to predict similarity jobs same company β_{jc} 270 and the member's profile (jobs same company) u_{jc,m} 266 using the Estimating (E) and Maximizing (M) steps. The job recommendation engine 112 may repeat the Estimating (E) and Maximizing (M) steps until a change of coefficients to predict similarity jobs same company tβ_{jc} 270 is below a predetermined threshold and/or the member's profile (jobs same company) u_{jc,m} 266 is below a predetermined threshold.

θ={θ₁,θ₂, . . . ,θ_{M}}, Equation (6):

where θ is a set of hidden variables that, in some embodiments, are generated by the job recommendation engine 112 (e.g., coefficient and profile determiner 206) and represent the latent preferences of member M based on one or more of the similarity jobs and member Y_{j,m,k} 252, similarity jobs same company Y_{jc,m,k} 254, and job profile Jₖ 256. The set of hidden variables θ may be used by the job recommendation engine 112 (e.g., the coefficient and profile determiner 206) to generate the member's profile (jobs and member) u_{j,m} 264, member's profile (jobs same company) u_{jc,m} 266.

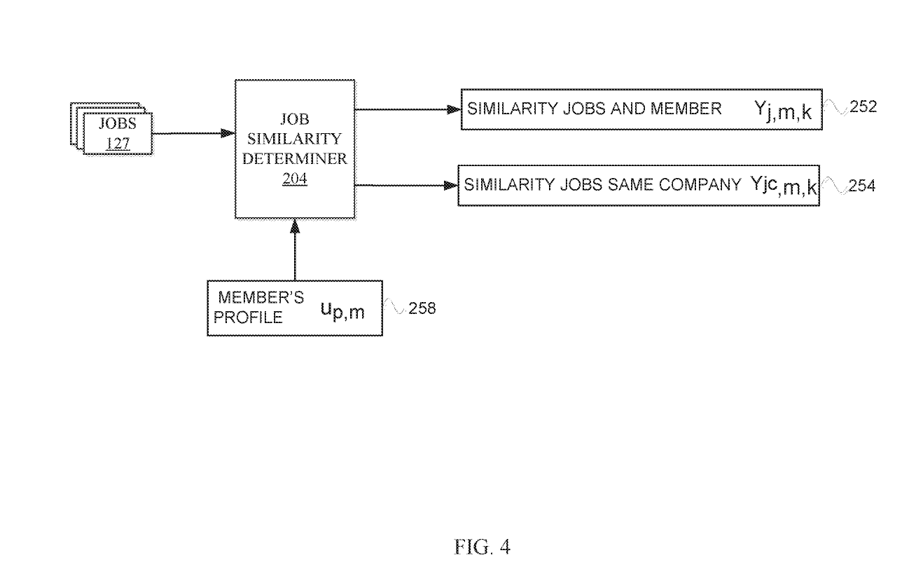

FIG. 4 illustrates the job similarity determiner 204 in accordance with some embodiments. Illustrated in FIG. 4 is jobs 127, job similarity determiner 204, member's profile u_{p,m} 258, similarity jobs and member Y_{j,m,k} 252, and similarity jobs same company Y_{jc,m,k} 254.

The job similarity determiner 204 is configured to compare jobs 127 with member's profile u_{p,m} 258 to determine similarity jobs and member Y_{j,m,k} 252, and similarity jobs same company Y_{jc,m,k} 254. Similarity jobs and member Y_{j,m,k} 252 may be a 1 if the kth job 127 for member m is determined to be similar to member's profile u_{p,m} 258. The job similarity determiner 204 compares fields of a current job (as indicated in the of the member's profile u_{p,m} 258) with the kth job 127 with job profile Jₖ 256, in accordance with some embodiments. For example, the job similarity determiner 204 compares a job title of Table 1 (job profile fields) with a job title of Table 2 (member profile fields). For similarity jobs same company Y_{jc,m,k} 254, the job similarity determiner 204 compares fields of the job profile Jₖ 256 with the member's profile u_{p,m} 258 to determine if it is the same company. The similarity jobs same company Y_{jc,m,k} 254 is set to 1 if they are the same company and other fields indicate the jobs are similar, and otherwise it is set to −1, in accordance with some embodiments.

In some embodiments, the job similarity determiner 204 compares all of the fields of a current job (as indicated in the of the member's profile u_{p,m} 258) with the kth job 127 with job profile Jₖ 256, and determines a score of closeness, in accordance with some embodiments. In some embodiments, the job similarity determiner 204 may build a dictionary of synonyms that it uses to compare the fields. In some embodiments, the job similarity determiner 204 may build a hierarchy and ranking of terms to use to compare fields, e.g., information technology may be ranked as being closer to developer than salesperson. In some embodiments, the job similarity determiner 204 determines one or more first job profiles that are similar to a second job profile of the member of the social network system by comparing one or more fields of the one or more first job profiles with the second job profile and determining a score for how closely fields of the one or more fields match with fields of the second job profile.

FIG. 5 illustrates a method 500 for generating job recommendations in accordance with some embodiments. The method 500 begins at operation 502 with selecting, by at least one hardware processor, one or more first job profiles that are similar to a second job profile of a member of a social network system. For example, job similarity determiner 204 (FIG. 2) may determine which jobs 127 (FIG. 1) are similar to member's profile u_{p,m} 258 as disclosed in conjunction with FIGS. 1-4 to determine similarity jobs and member Y_{j,m,k} 252 for member m and for each job k of jobs 127. The job similarity determiner 204 may then select those jobs 127 that are similar.

The method 500 continues at operation 504 with determining, by at least one hardware processor, first regression coefficients and a first hidden feature vector jointly for a first layer based on the one or more first job profiles and a profile of the member, the profile comprising the second job profile. For example, the method 600 may be used to determine first regression coefficients and a first hidden feature vector jointly. Additionally, coefficient and profile determiner 206 may determine similarity jobs and member Y_{j,m,k} 252 and member's profile (jobs and member) u_{j,m} 264.

The method 500 continues at operation 506 with determining, by at least one hardware processor, one or more third job profiles that are similar to the second job profile of a member of a social network system, wherein the one or more third job profiles are from a same company as the second job profile of the member of a social network system. For example, job similarity determiner 204 (FIG. 2) may determine which jobs 127 (FIG. 1) are of a same company as a current job (or previous job with no current job) of the member's profile u_{p,m} 258 as disclosed in conjunction with FIGS. 1-4 to determine similarity jobs same company Y_{jc,m,k} 254 for member m and for each job k of jobs 127. In some embodiments, only jobs 127 are considered that have are indicated as similar by similarity jobs and member Y_{j,m,I} 252.

The method 500 continues at operation 508 with determining, by the at least one hardware processor, second regression coefficients and a second hidden feature vector jointly for a second layer based on the first regression coefficients, the first hidden feature vector, and the one or more third job profiles. For example, the method 600 may be used to determine second regression coefficients and a second hidden feature vector jointly. Additionally, coefficient and profile determiner 206 may determine similarity jobs same company Y_{jc,m,k} 254 and member's profile (jobs same company) u_{jc,m} 266 based on member's profile (jobs and member) u_{j,m} 264 and similarity jobs and member Y_{j,m,I} 252.

The method 500 continues at operation 510 with determining, by the at least one hardware processor, a job recommendation based on one or more job profiles, the first regression coefficients, first hidden feature vector, second regression coefficients, and second hidden feature vector. For example, the job recommendation engine 112 may determine job recommendations 208 from jobs 127 based on the coefficients to predict similarity jobs, member βⱼ 268, coefficients to predict similarity jobs same company β_{jc} 270, member's profile (jobs and member) u_{j,m} 264, and member's profile (jobs same company) u_{jc,m} 266.

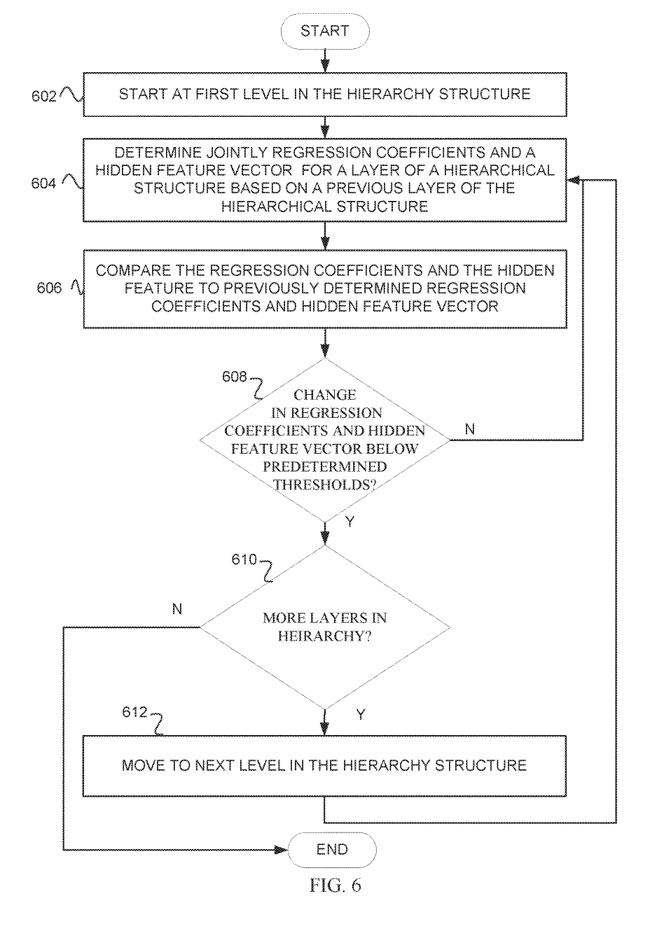

FIG. 6 illustrates a method 600 of determining regression coefficients and a hidden feature vector of a hierarchical structure in accordance with some embodiments. The method 600 begins at operation 602 with start at a first level in the hierarchy structure. For example, in hierarchical member interaction structure 300 (FIG. 3) there is a first level where member's profile (jobs and member) u_{j,m} 264 and coefficients to predict similarity jobs and member βⱼ 268 are determined.

The method 600 continues at operation 604 with determining jointly regression coefficients and a hidden feature vector for a layer of a hierarchical structure based on a previous layer of the hierarchical structure. For example, the job recommendation engine 112 may use the Estimate (E) and Maximizing (M) steps where in the E step the regression coefficients are fixed and in the M step the latent feature vector is fixed. For example, in the first layer of hierarchical member interaction structure 300 (FIG. 3), the regression coefficients are coefficients to predict similarity jobs and member βⱼ 268 and the latent feature vector is member's profile (jobs and member) u_{j,m} 264, which may be determined based on the member's profile u_{p,m} 258 and the similarity jobs and member Y_{j,m,I} 252. In the second layer of hierarchical member interaction structure 300 (FIG. 3), the regression coefficients are coefficients to predict similarity jobs same company β_{jc} 270 and the latent feature vector is member's profile (jobs same company) u_{jc,m} 266, which may be determined based on the member's profile (jobs and member) u_{j,m} 264 and similarity jobs same company Y_{jc,m,k} 254.

The method 600 continues at operation 606 with comparing the regression coefficients and the hidden feature to previously determined regression coefficients and hidden feature vector. For example, at operation 604 approximations of coefficients to predict similarity jobs and member βⱼ 268 and member's profile (jobs and member) u_{j,m} 264 may have been determined with one or more iterations of the E and M steps. These values are compared with previous approximations of coefficients to predict similarity jobs and member βⱼ 268 and member's profile (jobs and member) u_{j,m} 264. For the second layer of hierarchical member interaction structure 300 (FIG. 3), approximations of coefficients to predict similarity jobs same company β_{jc} 270 and member's profile (jobs same company) u_{jc,m} 266 are determined in the M and E steps, respectively.

The method 600 continues at operation 608 with determining if the changes in regression coefficients and hidden feature vector are below predetermined thresholds. For example, there may be predetermined thresholds for change in the regression coefficients and the change in the hidden feature vector.

If the changes are not below predetermined thresholds, the method 600 returns to operation 604. If the changes are below predetermined thresholds, then the method 600 continues at operation 610 with more layers in hierarchy. If there are more layers in the hierarchy, then the method 600 continues at operation 612 with move to next level in the hierarchy structure. For example, the next level is the second layer of hierarchical member interaction structure 300 (FIG. 3).

The method 600 returns to operation 604 with the next level in the hierarchy structure. For example, coefficients to predict similarity jobs same company β_{jc} 270 and member's profile (jobs same company) u_{jc,m} may be determined based on the previously determined coefficients to predict similarity jobs and member βⱼ 268 and member's profile (jobs and member) u_{j,m} 264. Returning back to operation 610, the method 600 ends if there are no more layers in the hierarchy.

Some embodiments require less time to determine job recommendations because they use a hierarchical structure that depends on the previous levels of the hierarchical structure.

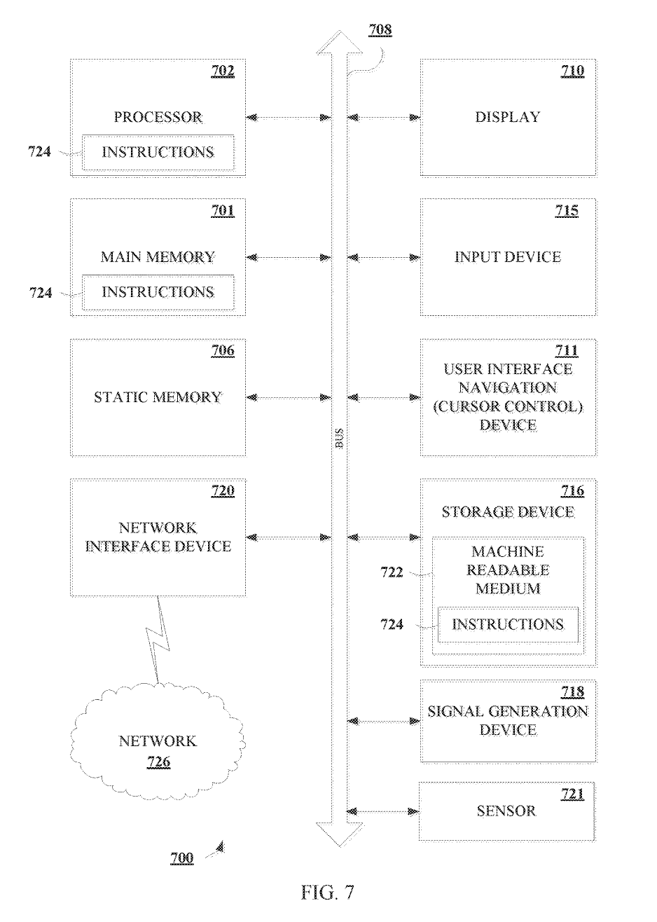

FIG. 7 shows a diagrammatic representation of the machine 700 in the example form of a computer system and within which instructions 724 (e.g., software) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alphanumeric input device 715 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 (e.g., software) embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The following examples pertain to further embodiments. Specifics in the examples may be used in one or more embodiments. Example 1 is a method of generating a job recommendation, the method including: selecting, by at least one hardware processor, one or more first job profiles that are similar to a second job profile of a member of a social network system; determining, by at least one hardware processor, first regression coefficients and a first hidden feature vector jointly for a first layer of a hierarchical structure based on the one or more first job profiles and the second job profile; determining, by at least one hardware processor, one or more third job profiles that are similar to the second job profile, where the one or more third job profiles are from a same company as the second job profile; determining, by the at least one hardware processor, second regression coefficients and a second hidden feature vector jointly for a second layer of the hierarchical structure based on the first regression coefficients, the first hidden feature vector, and the one or more third job profiles; determining, by the at least one hardware processor, a job recommendation based on one or more job profiles, the first regression coefficients, first hidden feature vector, second regression coefficients, and second hidden feature vector; and causing to be displayed, on a display communicatively coupled to the at least one hardware processor, the job recommendation to the member.

In Example 2, the subject matter of Example 1 optionally includes determining, by the at least one hardware processor, the job recommendation using an iterative Bayesian method to increase the likelihood that the member will apply to the recommended job.

In Example 3, the subject matter of any one or more of Examples 1-2 optionally include determining, by at least one hardware processor, a first approximation of the first hidden feature vector while keeping the first regression coefficients fixed, where the determining is based on the one or more first job profiles and the profile of the member, the profile including the second job profile; and determining, by at least one hardware processor, a first approximation of the first regression coefficients while keeping the first approximation of the first hidden feature vector fixed, where the determining is based on the one or more first job profiles and the profile of the member, the profile including the second job profile.

In Example 4, the subject matter of Example 3 optionally includes determining, by at least one hardware processor, a second approximation of the first hidden feature vector while keeping the first approximation of the first regression coefficients fixed, where the determining is based on the one or more first job profiles and the profile of the member, the profile including the second job profile; and determining, by at least one hardware processor, a second approximation of the first regression coefficients while keeping the second approximation of the first hidden feature vector fixed, where the determining is based on the one or more first job profiles and the profile of the member, the profile including the second job profile.

In Example 5, the subject matter of Example 4 optionally includes determining, by at least one hardware processor, a first change between the first approximation of the first hidden feature vector and the second approximation of the first hidden feature vector; determining, by at least one hardware processor, a second change between the first approximation of the first regression coefficients and a second approximation of the first regression coefficients; and repeating, by at least one hardware processor, the determining of approximations of the first hidden feature vector and the first regression coefficients until the first change is below a first predetermined threshold and the second change is below a second predetermined threshold.

In Example 6, the subject matter of Example 5 optionally includes determining, by the at least one hardware processor, third regression coefficients and a third hidden feature vector jointly for a third layer of the hierarchical structure based on the second regression coefficients, the second hidden feature vector, and the one or more third job profiles; determining, by the at least one hardware processor, a second job recommendation based on one or more job profiles, the first regression coefficients, the first hidden feature vector, the second regression coefficients, the second hidden feature vector, the third regression coefficients, and the third hidden feature vector; and causing to be displayed, on the display, the second job recommendation to the member.

In Example 7, the subject matter of any one or more of Examples 1-6 optionally include where the one or more first job profiles are selected from a database of job profiles of job openings.

In Example 8, the subject matter of any one or more of Examples 1-7 optionally include determining, by at least one hardware processor, one or more first job profiles that are similar to a second job profile of the member of the social network system by comparing one or more fields of the one or more first job profiles with the second job profile and determining a score for how closely fields of the one or more fields match with fields of the second job profile.

Example 9 is a system including: a machine-readable medium storing computer-executable instructions; and at least one hardware processor communicatively coupled to the machine-readable medium that, when the computer-executable instructions are executed, the at least one hardware processor is configured to: determine, by at least one hardware processor, one or more first job profiles that are similar to a second job profile of a member of a social network system; determine, by at least one hardware processor, first regression coefficients and a first hidden feature vector jointly for a first layer of a hierarchical structure based on the one or more first job profiles and the second job profile; determine, by at least one hardware processor, one or more third job profiles that are similar to the second job profile, where the one or more third job profiles are from a same company as the second job profile; determine, by the at least one hardware processor, second regression coefficients and a second hidden feature vector jointly for a second layer of the hierarchical structure based on the first regression coefficients, the first hidden feature vector, and the one or more third job profiles; and determine, by the at least one hardware processor, a job recommendation based on one or more job profiles, the first regression coefficients, first hidden feature vector, second regression coefficients, and second hidden feature vector.

In Example 10, the subject matter of Example 9 optionally includes where the at least one hardware processor is further configured to: cause to be displayed, on a display communicatively coupled to the at least one hardware processor, the job recommendation to the member.

In Example 11, the subject matter of any one or more of Examples 9-10 optionally include where the at least one hardware processor is further configured to: determine, by the at least one hardware processor, the job recommendation using an iterative Bayesian method to increase the likelihood that the member will apply to the recommended job.

In Example 12, the subject matter of any one or more of Examples 9-11 optionally include where the at least one hardware processor is further configured to: determine, a first approximation of the first hidden feature vector while keeping the first regression coefficients fixed, where the determining is based on the one or more first job profiles and the profile of the member, the profile including the second job profile; and determine, a first approximation of the first regression coefficients while keeping the first approximation of the first hidden feature vector fixed, where the determining is based on the one or more first job profiles and the profile of the member, the profile including the second job profile.

In Example 13, the subject matter of Example 12 optionally includes where the at least one hardware processor is further configured to: determine a second approximation of the first hidden feature vector while keeping the first approximation of the first regression coefficients fixed, where the determining is based on the one or more first job profiles and the profile of the member, the profile including the second job profile; and determine a second approximation of the first regression coefficients while keeping the second approximation of the first hidden feature vector fixed, where the determining is based on the one or more first job profiles and the profile of the member, the profile including the second job profile.

In Example 14, the subject matter of Example 13 optionally includes where the at least one hardware processor is further configured to: determine a first change between the first approximation of the first hidden feature vector and the second approximation of the first hidden feature vector; determine a second change between the first approximation of the first regression coefficients and a second approximation of the first regression coefficients; and repeat the determining of approximations of the first hidden feature vector and the first regression coefficients until the first change is below a first predetermined threshold and the second change is below a second predetermined threshold.

Example 15 is a machine-readable medium storing computer-executable instructions stored thereon that, when executed by at least one hardware processor, cause the at least one hardware processor to perform a plurality of operations, the operations including: determining one or more first job profiles that are similar to a second job profile of a member of a social network system; determining first regression coefficients and a first hidden feature vector jointly for a first layer of a hierarchical structure based on the one or more first job profiles and the second job profile; determining one or more third job profiles that are similar to the second job profile, where the one or more third job profiles are from a same company as the second job profile; determining second regression coefficients and a second hidden feature vector jointly for a second layer of the hierarchical structure based on the first regression coefficients, the first hidden feature vector, and the one or more third job profiles; and determining a job recommendation based on one or more job profiles, the first regression coefficients, first hidden feature vector, second regression coefficients, and second hidden feature vector.

In Example 16, the subject matter of Example 15 optionally includes where the plurality of operations further comprise: displaying, on a display, the job recommendation to the member.

In Example 17, the subject matter of any one or more of Examples 15-16 optionally include where the plurality of operations further comprise: determining a first approximation of the first hidden feature vector while keeping the first regression coefficients fixed, where the determining is based on the one or more first job profiles and the profile of the member, the profile including the second job profile; and determining a first approximation of the first regression coefficients while keeping the first approximation of the first hidden feature vector fixed, where the determining is based on the one or more first job profiles and the profile of the member, the profile including the second job profile.

In Example 18, the subject matter of Example 17 optionally includes where the plurality of operations further comprise: determining a second approximation of the first hidden feature vector while keeping the first approximation of the first regression coefficients fixed, where the determining is based on the one or more first job profiles and the profile of the member, the profile including the second job profile; and determining a second approximation of the first regression coefficients while keeping the second approximation of the first hidden feature vector fixed, where the determining is based on the one or more first job profiles and the profile of the member, the profile including the second job profile.

In Example 19, the subject matter of Example 18 optionally includes where the plurality of operations further comprise: determining a first change between the first approximation of the first hidden feature vector and the second approximation of the first hidden feature vector; determining a second change between the first approximation of the first regression coefficients and a second approximation of the first regression coefficients; and repeating the determining of approximations of the first hidden feature vector and the first regression coefficients until the first change is below a first predetermined threshold and the second change is below a second predetermined threshold.

In Example 20, the subject matter of any one or more of Examples 15-19 optionally include where the plurality of operations further comprise: determining one or more first job profiles that are similar to a second job profile of the member of the social network system by comparing one or more fields of the one or more first job profiles with the second job profile and determining a score for how closely fields of the one or more fields match with fields of the second job profile.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of generating a job recommendation, the method comprising:
selecting, by at least one hardware processor, one or more first job profiles that are similar to a second job profile of a member of a social network system;
determining, by at least one hardware processor, first regression coefficients and a first hidden feature vector jointly for a first layer of a hierarchical structure based on the one or more first job profiles and the second job profile;
determining, by at least one hardware processor, one or more third job profiles that are similar to the second job profile, wherein the one or more third job profiles are from a same company as the second job profile;
determining, by the at least one hardware processor, second regression coefficients and a second hidden feature vector jointly for a second layer of the hierarchical structure based on the first regression coefficients, the first hidden feature vector, and the one or more third job profiles;
determining, by the at least one hardware processor, a job recommendation based on one or more job profiles, the first regression coefficients, first hidden feature vector, second regression coefficients, and second hidden feature vector; and
causing to be displayed, on a display communicatively coupled to the at least one hardware processor, the job recommendation to the member.

2. The method of claim 1, further comprising:
determining, by the at least one hardware processor, the job recommendation using an iterative Bayesian method to increase the likelihood that the member will apply to the recommended job.

3. The method of claim 1, further comprising:
determining, by at least one hardware processor, a first approximation of the first hidden feature vector while keeping the first regression coefficients fixed, wherein the determining is based on the one or more first job profiles and the profile of the member, the profile comprising the second job profile; and
determining, by at least one hardware processor, a first approximation of the first regression coefficients while keeping the first approximation of the first hidden feature vector fixed, wherein the determining is based on the one or more first job profiles and the profile of the member, the profile comprising the second job profile.

4. The method of claim 3, further comprising:
determining, by at least one hardware processor, a second approximation of the first hidden feature vector while keeping the first approximation of the first regression coefficients fixed, wherein the determining is based on the one or more first job profiles and the profile of the member, the profile comprising the second job profile; and
determining, by at least one hardware processor, a second approximation of the first regression coefficients while keeping the second approximation of the first hidden feature vector fixed, wherein the determining is based on the one or more first job profiles and the profile of the member, the profile comprising the second job profile.

5. The method of claim 4, further comprising:
determining, by at least one hardware processor, a first change between the first approximation of the first hidden feature vector and the second approximation of the first hidden feature vector;
determining, by at least one hardware processor, a second change between the first approximation of the first regression coefficients and a second approximation of the first regression coefficients; and
repeating, by at least one hardware processor, the determining of approximations of the first hidden feature vector and the first regression coefficients until the first change is below a first predetermined threshold and the second change is below a second predetermined threshold.

6. The method of claim 5, further comprising:
determining, by the at least one hardware processor, third regression coefficients and a third hidden feature vector jointly for a third layer of the hierarchical structure based on the second regression coefficients, the second hidden feature vector, and the one or more third job profiles;
determining, by the at least one hardware processor, a second job recommendation based on one or more job profiles, the first regression coefficients, the first hidden feature vector, the second regression coefficients, the second hidden feature vector, the third regression coefficients, and the third hidden feature vector; and
causing to be displayed, on the display, the second job recommendation to the member.

7. The method of claim 1, wherein the one or more first job profiles are selected from a database of job profiles of job openings.

8. The method of claim 1, further comprising:
determining, by at least one hardware processor, one or more first job profiles that are similar to a second job profile of the member of the social network system by comparing one or more fields of the one or more first job profiles with the second job profile and determining a score for how closely fields of the one or more fields match with fields of the second job profile.

9. A system comprising:
a machine-readable medium storing computer-executable instructions; and
at least one hardware processor communicatively coupled to the machine-readable medium that, when the computer-executable instructions are executed, the at least one hardware processor is configured to:
determine, by at least one hardware processor, one or more first job profiles that are similar to a second job profile of a member of a social network system;
determine, by at least one hardware processor, first regression coefficients and a first hidden feature vector jointly for a first layer of a hierarchical structure based on the one or more first job profiles and the second job profile;
determine, by at least one hardware processor, one or more third job profiles that are similar to the second job profile, wherein the one or more third job profiles are from a same company as the second job profile;
determine, by the at least one hardware processor, second regression coefficients and a second hidden feature vector jointly for a second layer of the hierarchical structure based on the first regression coefficients, the first hidden feature vector, and the one or more third job profiles; and
determine, by the at least one hardware processor, a job recommendation based on one or more job profiles, the first regression coefficients, first hidden feature vector, second regression coefficients, and second hidden feature vector.

10. The system of claim 9, wherein the at least one hardware processor is further configured to:
cause to be displayed, on a display communicatively coupled to the at least one hardware processor, the job recommendation to the member.

11. The system of claim 9, wherein the at least one hardware processor is further configured to:
determine, by the at least one hardware processor, the job recommendation using an iterative Bayesian method to increase the likelihood that the member will apply to the recommended job.

12. The system of claim 9, wherein the at least one hardware processor is further configured to:
determine, a first approximation of the first hidden feature vector while keeping the first regression coefficients fixed, wherein the determining is based on the one or more first job profiles and the profile of the member, the profile comprising the second job profile; and
determine, a first approximation of the first regression coefficients while keeping the first approximation of the first hidden feature vector fixed, wherein the determining is based on the one or more first job profiles and the profile of the member, the profile comprising the second job profile.

13. The system of claim 12, wherein the at least one hardware processor is further configured to:
determine a second approximation of the first hidden feature vector while keeping the first approximation of the first regression coefficients fixed, wherein the determining is based on the one or more first job profiles and the profile of the member, the profile comprising the second job profile; and
determine a second approximation of the first regression coefficients while keeping the second approximation of the first hidden feature vector fixed, wherein the determining is based on the one or more first job profiles and the profile of the member, the profile comprising the second job profile.

14. The system of claim 13, wherein the at least one hardware processor is further configured to:
determine a first change between the first approximation of the first hidden feature vector and the second approximation of the first hidden feature vector;
determine a second change between the first approximation of the first regression coefficients and a second approximation of the first regression coefficients; and
repeat the determining of approximations of the first hidden feature vector and the first regression coefficients until the first change is below a first predetermined threshold and the second change is below a second predetermined threshold.

15. A machine-readable medium storing computer-executable instructions stored thereon that, when executed by at least one hardware processor, cause the at least one hardware processor to perform a plurality of operations, the operations comprising:
determining one or more first job profiles that are similar to a second job profile of a member of a social network system;
determining first regression coefficients and a first hidden feature vector jointly for a first layer of a hierarchical structure based on the one or more first job profiles and the second job profile;
determining one or more third job profiles that are similar to the second job profile, wherein the one or more third job profiles are from a same company as the second job profile;
determining second regression coefficients and a second hidden feature vector jointly for a second layer of the hierarchical structure based on the first regression coefficients, the first hidden feature vector, and the one or more third job profiles; and
determining a job recommendation based on one or more job profiles, the first regression coefficients, first hidden feature vector, second regression coefficients, and second hidden feature vector.

16. The machine-readable medium of claim 15, wherein the plurality of operations further comprise:
displaying, on a display, the job recommendation to the member.

17. The machine-readable medium of claim 15, wherein the plurality of operations further comprise:
determining a first approximation of the first hidden feature vector while keeping the first regression coefficients fixed, wherein the determining is based on the one or more first job profiles and the profile of the member, the profile comprising the second job profile; and
determining a first approximation of the first regression coefficients while keeping the first approximation of the first hidden feature vector fixed, wherein the determining is based on the one or more first job profiles and the profile of the member, the profile comprising the second job profile.

18. The machine-readable medium of claim 17, wherein the plurality of operations further comprise:
determining a second approximation of the first hidden feature vector while keeping the first approximation of the first regression coefficients fixed, wherein the determining is based on the one or more first job profiles and the profile of the member, the profile comprising the second job profile; and
determining a second approximation of the first regression coefficients while keeping the second approximation of the first hidden feature vector fixed, wherein the determining is based on the one or more first job profiles and the profile of the member, the profile comprising the second job profile.

19. The machine-readable medium of claim 18, wherein the plurality of operations further comprise:
determining a first change between the first approximation of the first hidden feature vector and the second approximation of the first hidden feature vector;
determining a second change between the first approximation of the first regression coefficients and a second approximation of the first regression coefficients; and
repeating the determining of approximations of the first hidden feature vector and the first regression coefficients until the first change is below a first predetermined threshold and the second change is below a second predetermined threshold.

20. The machine-readable medium of claim 15, wherein the plurality of operations further comprise:
determining one or more first job profiles that are similar to a second job profile of the member of the social network system by comparing one or more fields of the one or more first job profiles with the second job profile and determining a score for how closely fields of the one or more fields match with fields of the second job profile.
